(19) United States
(12) Patent Application Publication
(10) Pub. No.: US 2026/0208869 A1
(43) Pub. Date: Jul. 23, 2026

(54) AERONAUTICAL PROPULSION SYSTEM HAVING IMPROVED PROPULSION EFFICIENCY

(71) Applicant: SAFRAN AIRCRAFT ENGINES, Paris (FR)

(72) Inventor: Didier René André ESCURE, MOISSY-CRAMAYEL (FR)

(73) Assignee: SAFRAN AIRCRAFT ENGINES, Paris (FR)

(21) Appl. No.: 19/141,454

(22) PCT Filed: Dec. 22, 2023
(86) PCT No.: PCT/FR2023/052103

§ 371 Date: Jun. 20, 2025

(30) Foreign Application Priority Data
Dec. 22, 2022 (FR) 2214335

(51) Int. Cl. B64D 27/12; B64C 11/00; B64C 11/18; B64D 27/40; B64D 35/00; B64F 5/00

(52) U.S. Cl. CPC B64D 27/12; B64C 11/001; B64C 11/18; B64D 27/402; B64D 35/00; B64F 5/00

(57) ABSTRACT

An aeronautical propulsion system includes drive and fan shafts, a fan section including an unducted fan rotor that includes blades, and a reduction structure coupling the drive and fan shafts to drive the fan shaft at a rotation speed less than the rotation speed of the drive shaft. The fan rotor has an aerodynamic load parameter greater than or equal to 0.07 and less than or equal to 0.12, and a mechanical load parameter greater than or equal to 11.5×10⁶ rev·m²·min⁻¹ and less than or equal to 20.0×10⁶ rev·m²·min⁻¹. The aerodynamic load and the mechanical load are defined based on the load parameters, a thrust and bypass ratio of the propulsion system, the number of the blades, a constant, outer and inner radiuses and a redline speed of the fan rotor, and a surface area of the flow stream at the inlet of the fan rotor.

### TECHNICAL FIELD

The present application generally relates to the field of propulsion systems, and more particularly to aeronautical propulsion systems comprising an unducted fan with a high or even very high bypass ratio.

### BACKGROUND

A propulsion system generally comprises, from upstream to downstream in the direction of gas flow, a fan section, a compressor section which may comprise a low-pressure compressor and a high-pressure compressor, a combustion chamber and a turbine section which may comprise, in particular, a high-pressure turbine and a low-pressure turbine. The high-pressure compressor is rotated by the high-pressure turbine via a high-pressure shaft. The fan and, if applicable, the low-pressure compressor are rotated by the low-pressure turbine via a low-pressure shaft.

Technological research efforts have already enabled significant improvements in the environmental performance of aircraft. The Applicant takes into account the impacting factors in all phases of design and development in order to obtain aeronautical components and products that consume less energy, are more environmentally friendly and whose integration and use in civil aviation has moderate environmental consequences, with the aim of improving aircraft energy efficiency.

In order to improve the propulsion efficiency of the propulsion system and reduce its specific consumption and the noise emitted by the fan section, propulsion systems having a high BPR (bypass ratio, corresponding to the ratio between the secondary air flow and the primary air flow) have been proposed. To achieve such bypass ratios, the fan section can be decoupled from the low-pressure turbine, thus enabling their respective rotation speeds to be independently optimised. In general, decoupling is achieved by means of a reduction mechanism placed between the upstream end of the low-pressure shaft and a rotor of the fan section. The rotor of the fan section is then driven by the low-pressure shaft, via the reduction mechanism, at a lower rotation speed than that of the low-pressure shaft.

This decoupling enables the fan rotor rotation speed to be reduced. Furthermore, in order to reduce the pressure ratio of the fan rotor and improve the bypass ratio of the propulsion system, it has been proposed to increase the diameter of the fan rotor (and therefore to reduce the peripheral speed of the fan blades). The result is a reduction in the centrifugal forces in the fan rotor. However, increasing the diameter of the fan has a negative impact on the mass and drag of the fan section, and by extension on the propulsion system, and increases the torque to be applied by the fan shaft to the fan rotor.

### SUMMARY

One aim of the present application is to optimise the performance of the propulsion system, while maintaining acceptable mechanical and aerodynamic loading for the fan section of the propulsion system.

For this purpose, a first aspect of the invention proposes an aeronautical propulsion system comprising:
a drive shaft rotatable about an axis of rotation;
a fan shaft;
a fan section comprising an unducted fan rotor rotated by the fan shaft, the fan rotor comprising a plurality of blades, each blade;
a reduction mechanism coupling the drive shaft and the fan shaft in order to drive the fan shaft at a rotation speed less than the rotation speed of the drive shaft;
   the propulsion system being configured such that the fan rotor has an aerodynamic load parameter greater than or equal to 0.07 and less than or equal to 0.12 and a mechanical load parameter greater than or equal to 11.5×10⁶ rev·m²·min⁻¹ and less than or equal to 20.0×10⁶ rev·m²·min⁻¹,
   where the aerodynamic load and the mechanical load are defined by the following formulas:

$${k}_{a e r o} = \frac{F * {( F N * \frac{B P {R}^{0.2}}{1000} )}^{1.35}}{n \times \frac{{( ω * \frac{π}{30} )}^{2}}{4} \times ( {R}_{e}^{4} - {R}_{i}^{4} ) * ( {R}_{e} - {R}_{i} )}$$

$${k}_{m e c a} = {ω}^{2} \times S$$

and where: Kₐₑᵣₒ is the aerodynamic load parameter;
K_{meca} is the mechanical load parameter;
FN is the thrust generated by the propulsion system when the propulsion system is stationary, in take-off speed, in a standard atmosphere and at sea level and is expressed in newtons;
BPR is the bypass ratio of the propulsion system and is measured when the propulsion system is stationary, in take-off speed, in a standard atmosphere and at sea level;
n is the number of blades in the fan rotor;
F=39.7 N^{-1.35}·(rev/min)⁻²·m⁻⁵
Rₑ is the outer radius of the fan rotor and corresponds to a distance between the axis of rotation and a point of intersection between a tip and a leading edge of the blades of the fan rotor, and is expressed in metres (m);
Rᵢ is the inner radius of the fan rotor and corresponds to a distance between the axis of rotation and a point of intersection between the leading edge of the blades of the fan rotor and a surface of the fan rotor which radially inwardly delimits a flow stream in the fan rotor and is expressed in metres (m);
ω is the redline speed of the fan rotor and is expressed in revolutions per minute (rev/min); and
S is the surface area of the flow stream at the inlet of the fan rotor, which is equal to π×(Rₑ²−Rᵢ²) and is expressed in square metres (m²).

Some preferred, but non-limiting, characteristics of the propulsion system according to the first aspect are the following, taken individually or in combination:
the outer radius of the fan rotor is between 40 inches (101.6 cm) and 92.5 inches (233.7 cm) inclusive, for example between 60 inches (152.4 cm) and 85 inches (215.9 cm) inclusive, for example of order 478 inches (198.1 cm);
a hub-tip ratio of the fan rotor is between 0.22 and 0.32;
the fan rotor comprises at least twelve fan blades and at most eighteen fan blades, for example at least fourteen fan blades and at most sixteen fan blades;
a reduction ratio of the reduction mechanism is greater than or equal to 5.0 and less than or equal to 11.0;
a bypass ratio of the propulsion system is greater than or equal to 40, for example between 40 and 80 inclusive;
a peripheral speed at the tip of the blades of the fan rotor, when the propulsion system is stationary, in take-off speed, in a standard atmosphere and at sea level, is between 210 m/s and 260 m/s;
the fan section also has a fan compression ratio, corresponding to a pressure ratio between an outlet of the fan rotor and an inlet of the fan rotor, less than or equal to 1.45, for example less than or equal to 1.30;
the propulsion system is dimensioned such that a thrust of the propulsion system, when the propulsion system is stationary, in take-off speed and in a standard atmosphere, is between 18 000 lbf and 51 000 lbf;
the propulsion system further comprises a drive turbine and a compressor connected directly via the drive shaft, wherein the drive turbine comprises at least three and at most five stages;
the compressor comprises at least two and at most four stages;
the propulsion system further comprises a high-pressure turbine and a high-pressure compressor connected by means of a high-pressure shaft, the high-pressure shaft rotating faster than the drive shaft, the high-pressure turbine being two-stage; and/or
the high-pressure compressor comprises at least eight and at most eleven stages.

According to a second aspect, an aircraft is proposed comprising at least one propulsion system according to the first aspect, attached to the aircraft by means of a mast.

According to a third aspect, a method is proposed for dimensioning or manufacturing a propulsion system comprising a reduction mechanism coupling a drive shaft and an unducted fan rotor in order to drive the fan rotor at a speed less than a speed of the drive shaft, wherein the fan rotor has an aerodynamic load parameter greater than or equal to 0.07 and less than or equal to 0.12 and a mechanical load parameter greater than or equal to 11.5×10⁶ rev·m²·min⁻¹ and less than or equal to 20.0×10⁶ rev·m²·min⁻¹, where the aerodynamic load and the mechanical load are defined by the following formulas:

$${k}_{a e r o} = \frac{F * {( F N * \frac{B P {R}^{0.2}}{1000} )}^{1.35}}{n \times \frac{{( ω * \frac{π}{30} )}^{2}}{4} \times ( {R}_{e}^{4} - {R}_{i}^{4} ) * ( {R}_{e} - {R}_{i} )}$$

$${k}_{m e c a} = {ω}^{2} \times S$$

and where: Kₐₑᵣₒ is the aerodynamic load parameter;
K_{meca} is the mechanical load parameter;
FN is the thrust generated by the propulsion system when the propulsion system is stationary, in take-off speed, in a standard atmosphere and at sea level and is expressed in newtons (N);
BPR is the bypass ratio of the propulsion system and is measured when the propulsion system is stationary in take-off speed, in a standard atmosphere and at sea level;
n is the number of blades in the fan rotor;

$$F = 39.7 {N}^{- 1.35} . {( rev / min )}^{- 2} . {m}^{- 5}$$

Rₑ is the outer radius of the fan rotor and corresponds to a distance between the axis of rotation and a point of intersection between a tip and a leading edge of the blades of the fan rotor, and is expressed in metres (m);
R₁ is the inner radius of the fan rotor and corresponds to a distance between the axis of rotation and a point of intersection between the leading edge of the blades of the fan rotor and a surface of the fan rotor which radially inwardly delimits a flow stream in the fan rotor and is expressed in metres (m);
ω is the redline speed of the fan rotor and is expressed in revolutions per minute (rev/min); and
S is the surface area of the flow stream at the inlet of the fan rotor, which is equal to π×(Rₑ²−Rᵢ²) and is expressed in square metres (m²).

According to a fourth aspect, a method is proposed for manufacturing an aeronautical propulsion system comprising the following steps:
dimensioning the aeronautical propulsion system in accordance with the dimensioning method according to the third aspect; and
manufacturing the aeronautical propulsion system.

### DESCRIPTION OF THE FIGURES

Other features, aims and advantages of the invention will emerge from the following description, which is given purely by way of illustration and not being limiting and which should be read with reference to the attached drawings, in which:

FIG. 1 is a schematic, partial cross-sectional view of an example of a propulsion system according to a first embodiment, in which the fan section is unducted;

FIG. 2 is a schematic cross-sectional view of an example of a reduction mechanism according to a first alternative embodiment;

FIG. 3 is a schematic cross-sectional view of an example of a reduction mechanism according to a second alternative embodiment;

FIG. 4 is an example of an aircraft which can comprise at least one propulsion system in accordance with the first or second embodiment of the invention;

FIG. 5 is a flow diagram illustrating examples of steps in a dimensioning or manufacturing process in accordance with an embodiment of the invention.

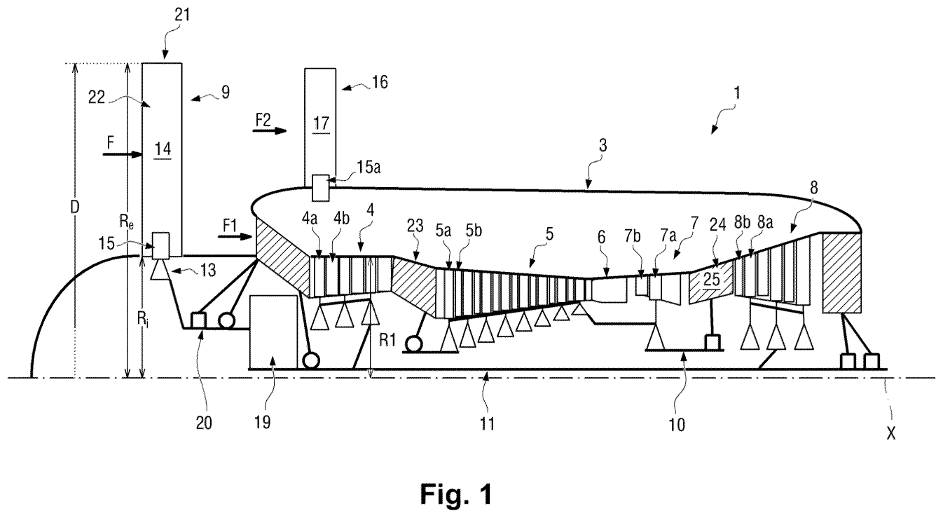

In all figures, similar elements have identical reference signs.

### DETAILED DESCRIPTION

A propulsion system 1 has a main direction extending along a longitudinal axis X and comprises, from upstream to downstream in the direction of gas flow in the propulsion system 1 when it is in operation, a fan section 2 and a primary spool 3, often referred to as a “gas generator”, comprising a compressor section 4, 5, a combustion chamber 6 and a turbine section 7, 8. Here, the propulsion system 1 is an aeronautical propulsion system 1 configured to be fixed to an aircraft 100 by means of a pylon (or mast).

The compressor section 4, 5 comprises a succession of stages each comprising a moving blade wheel (rotor) 4a, 5a rotating in front of a fixed vane wheel (stator) 4b, 5b. The turbine section 7, 8 also comprises a succession of stages each comprising a fixed vane wheel (stator) 7b, 8b behind which a moving blade wheel (rotor) 7a, 8a rotates.

In the present application, the axial direction corresponds to the direction of the longitudinal axis X, in correspondence with the rotation of the shafts of the gas generator, and a radial direction is a direction perpendicular to this axis X and passing through it. On the other hand, the circumferential (or lateral, or tangential) direction corresponds to a direction perpendicular to the longitudinal axis X and not passing through it. Unless specified otherwise, inner (respectively, interior) and outer (respectively, exterior), respectively, are used with reference to a radial direction such that the inner part or face of an element is closer to the axis X than the outer part or face of the same element.

In operation, an airflow F entering the propulsion system 1 is divided into a primary airflow F1 and a secondary airflow F2, which flow from upstream to downstream in the propulsion system 1.

The secondary airflow F2 (also known as the “bypass airflow”) flows around the primary spool 3. The secondary air flow F2 cools the periphery of the primary spool 3 and is used to generate most of the thrust provided by the propulsion system 1.

The primary air flow F1 flows in a primary duct inside the primary spool 3, passing successively through the compressor section 4, 5, the combustion chamber 6 where it is mixed with fuel to act as an oxidant, and the turbine section 7, 8. The passage of the primary air flow F1 through the turbine section 7, 8 receiving energy from the combustion chamber 6 causes a rotation of the rotor of the turbine section 7, 8, which in turn rotates the rotor of the compressor section 4, 5 and a rotor part 9 of the fan section 2.

In a twin-spool propulsion system 1, the compressor section 4, 5 may comprise a low-pressure compressor 4 and a high-pressure compressor 5. The turbine section 7, 8 may comprise a high-pressure turbine 7 and a low-pressure turbine 8. The rotor of the high-pressure compressor 5 is rotated by the high-pressure turbine 7 by means of a high-pressure shaft 10. The rotor of the low-pressure compressor 4 and the rotor part 9 of the fan section 2 are rotated by the low-pressure turbine rotor 8 by means of a low-pressure shaft 11. Thus, the primary spool 3 comprises a high-pressure spool including the high-pressure compressor 5, the high-pressure turbine 7 and the high-pressure shaft 10, and a low-pressure spool including the fan section 2, the low-pressure compressor 4, the low-pressure turbine 8 and the low-pressure shaft 11. The rotational speed of the high-pressure spool is higher than the rotational speed of the low-pressure spool. In a triple-spool propulsion system 1, the turbine section 7, 8 further comprises an intermediate turbine, positioned between the high-pressure turbine 7 and the low-pressure turbine 8 and configured to drive the rotor of the low-pressure compressor 4 by means of an intermediate shaft. The fan rotor 9 and the rotor of the high-pressure compressor 5 remain driven by the low-pressure shaft 11 and the high-pressure shaft 10, respectively.

The low-pressure shaft 11 is generally housed, over a section of its length, in the high-pressure shaft 10 and is coaxial with the high-pressure shaft 10. The low-pressure shaft 11 and the high-pressure shaft 10 can be co-rotating, i.e. driven in the same direction about the longitudinal axis X. Alternatively, the low-pressure shaft 11 and the high-pressure shaft can be counter-rotating, i.e. driven in opposite directions about the longitudinal axis X. If applicable, the intermediate shaft is housed between the high-pressure shaft 10 and the low-pressure shaft 11. The intermediate shaft and the low-pressure shaft 11 can be co-rotating or counter-rotating.

The fan section 2 comprises at least one fan rotor 9 able to be rotated relative to a stator part of the propulsion system by the turbine section 7, 8. Each fan rotor 9 comprises a hub 13 and blades 14 extending radially from the hub 13. The blades 14 of each rotor 9 have a variable pitch. The blade root 14 of each rotor 9 is pivotally mounted along a pitch axis and is connected to a pitch change mechanism mounted in the propulsion system 1, the pitch being adjusted as a function of the flight phases by the pitch change mechanism 15.

The fan section 2 may further comprise a fan stator 16, or flow straightener, which comprises vanes 17 mounted on a hub 18 of the fan stator 16 which have the function of straightening the secondary airflow F2 which flows out of the fan rotor 9. The vanes 17 of the fan stator 18 can be fixed relative to the hub 18 or have a variable pitch, in particular when the fan section 2 is unducted (see FIG. 2). In a similar way to the rotor blades 14, the root of the variable pitch stator vanes 17 is pivotally mounted along a pitch axis X and is connected to a pitch change mechanism 15a, which is generally separate from that of the fan rotor 9, the pitch being adjusted as a function of the flight phases by the pitch change mechanism.

In order to improve the propulsion efficiency of the propulsion system 1 and to reduce its specific consumption and the noise emitted by the fan section 2, the propulsion system 1 has a high bypass ratio. The term “high bypass ratio” shall mean a bypass ratio greater than or equal to 10, for example between 40 and 80 inclusive. To calculate the bypass ratio, the mass flow rate of the secondary air flow F2 and the mass flow rate of the primary air flow F1 are measured when the propulsion system 1 is stationary, uninstalled, in take-off speed, in a standard atmosphere (as defined by the International Civil Aviation Organisation (ICAO) manual, Doc 7488/3, 3^{rd} edition) and at sea level (so-called SLS conditions, for Seal Level Standard). It should be noted that, in the present application, the parameters (pressure, flow, thrust, speed, etc.) are systematically determined under these conditions. The term “uninstalled” is used here to mean that the measurements are carried out when the propulsion system 1 is on a test bench (and not installed on an aircraft 100), in which case the measurements are simpler to carry out. On the other hand, the distances (length, radius, diameter, etc.) are measured at ambient temperature (approximately 20° C.) when the propulsion system 1 is cold, i.e. when the propulsion system 1 has been stationary for a sufficient period of time for the parts of the propulsion system 1 to be at ambient temperature, it being understood that these dimensions vary little compared with the conditions under which the propulsion system 1 is in take-off speed.

The fan rotor 9 is decoupled from the low-pressure shaft 11 by means of a reduction mechanism 19, placed between an upstream end of the low-pressure shaft 11 and the fan rotor 9, in order to independently optimise their respective rotation speed. In this case, the propulsion system 1 also includes an additional shaft, referred to as the fan shaft 20. The low-pressure shaft 11 connects the low-pressure turbine 8 to an input of the reduction mechanism 19, while the fan shaft 20 connects the output of the reduction mechanism 19 to the fan rotor 9. The fan rotor 9 is therefore driven by the low-pressure shaft 11 via the reduction mechanism 19 and the fan shaft 20, at a rotation speed less than the rotation speed of the low-pressure turbine 8.

This decoupling makes it possible to reduce the rotation speed and the pressure ratio of the fan rotor 9 and to increase the power extracted by the low-pressure turbine 8. The overall efficiency of propulsion systems is determined to first order by the propulsion efficiency, which is favourably influenced by minimising the variation in kinetic energy of the air as it passes through the propulsion system 1. In a propulsion system 1 with a high bypass ratio, most of the flow generating the propulsive force is made up of the secondary air flow F2 of the propulsion system 1, the kinetic energy of the secondary air flow F2 being mainly affected by the compression to which the secondary air flow F2 is subjected as it passes through the fan section 2. Propulsion efficiency and the pressure ratio of the fan section 2 are therefore linked: the lower the pressure ratio of the fan section 2, the better will be the propulsion efficiency. In order to optimise the propulsion efficiency of the propulsion system 1, the fan pressure ratio, which corresponds to the ratio between the average pressure at the outlet of the fan stator 17 (or, in the absence of a stator, of the fan rotor 9) and the average pressure at the inlet of the fan rotor 9, is less than or equal to 1.70, for example less than or equal to 1.50, for example between 1.05 and 1.45. The average pressures are measured here over the height of the blade 14 (from the surface which radially delimits the internal flow stream of the fan rotor 9 to the tip 21 of the fan blade 14).

The fan section 2 may be unducted.

The fan section 2 (which may also be referred to as the propeller) is not surrounded by a fan casing. As the fan section 2 is unducted, the blades 14 of the fan rotor 9 have a variable pitch. Propulsion systems comprising at least one unducted fan rotor 9 are known as “open rotor” or “unducted fan”. The propulsion system 1 may comprise two unducted and counter-rotating fan rotors 9. Such a propulsion system 1 is known by the acronym CROR for “Contra-Rotating Open Rotor” or UDF for “Unducted Double Fan”. The fan rotor or rotors 9 can be positioned at the rear of the primary spool 3 so as to be of the pusher type, or at the front of the primary spool 3 so as to be of the tractor type. Alternatively, the propulsion system 1 may comprise a single unducted fan rotor 9 and an unducted fan stator 16 (flow straightener). Such a propulsion system 1 is known by the acronym USF for “Unducted Single Fan”. In the case of a propulsion system 1 of the USF type, the vanes 17 of the straightener 16 are fixed in rotation with respect to the axis X of rotation of the upstream fan rotor 9 and are therefore not subject to centrifugal force. The blades 17 of the flow straightener 16 also have variable pitch.

Eliminating the fairing around the fan section 2 makes it possible to increase the bypass ratio very significantly without the propulsion system 1 being penalised by the mass of the casings or nacelles designed to surround the fan section 2. The bypass ratio of the propulsion system 1 comprising an unducted fan section 2 is thus greater than or equal to 40, for example between 40 and 80 inclusive. The peripheral speed at the top 21 of the blades 14 of the fan rotor or rotors 9 can also be between 210 m/s and 260 m/s. The fan pressure ratio can then be between 1.05 and 1.20, for example.

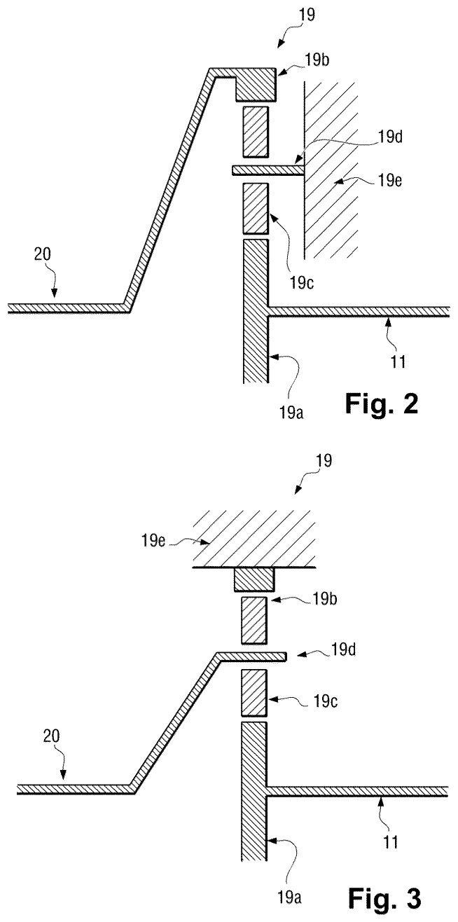

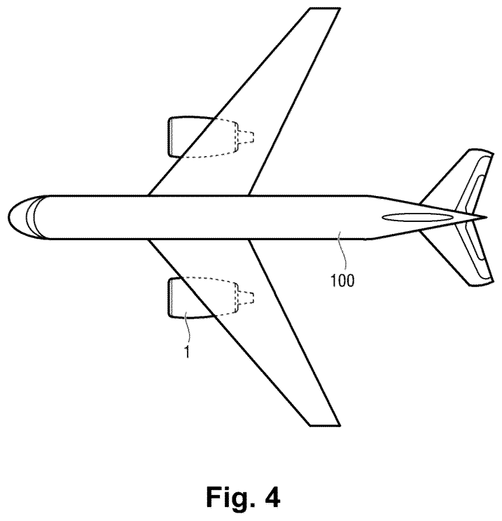

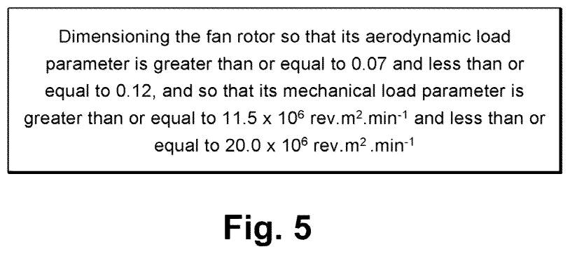

The reduction mechanism 19 may, for example, comprise a reduction mechanism 19 with an epicycloidal gear train, for example of the “epicycloidal” type or of the “planetary” type according to the terminology sometimes encountered by a person skilled in the art, single-stage or two-stage. According to a first variant, the reduction mechanism 19 can be of the planetary type (“star” in English) (FIG. 2) and comprise a sun gear 19a (input of the reduction mechanism 19), centred on an axis X of rotation of the reduction mechanism 19 (generally coincident with the longitudinal axis X) and configured to be rotated by the low-pressure shaft 11, a ring gear 19b (output of the reduction mechanism 19) coaxial with the sun gear 19a and configured to drive the fan shaft 20 in rotation about the axis X of rotation, and a series of planets 19c distributed circumferentially about the axis X of rotation between the sun gear 19a and the ring gear 19b, each planet 19c being meshed internally with the sun gear 19a and externally with the ring gear 19b. The series of planets 19c is mounted on a planet carrier 19d which is fixed relative to a stator part 19e of the propulsion system 1, for example relative to a casing of the compressor section 4, 5. According to a second variant, the reduction mechanism 19 may be of the “planetary” type (FIG. 3), in which case the ring gear 19b is fixedly mounted on the stator part 19e of the propulsion system 1 and the fan shaft 20 is rotated by the planet carrier 19d (which is therefore rotatable relative to a stator part 19e of the propulsion system 1, for example relative to a casing of the compressor section 4, 5).

Whatever the configuration of the reduction mechanism 19, the diameter of the ring gear 19b and the planet carrier 19d are greater than the diameter of the sun gear 19a, so that the rotation speed of the fan rotor 9 is lower than the rotation speed of the low-pressure shaft 11.

The redline speed of the low-pressure shaft 11, which corresponds to the absolute maximum speed likely to be encountered by the low-pressure shaft 11 throughout the flight (according to European certification regulation EASA CS-E 740 (or according to American certification regulation 14-CFR Part 33.87), is between 8500 rpm and 12,000 rpm, for example between 9000 rpm and 11,000 rpm. The redline speed corresponds to the maximum rotation speed when the propulsion system is healthy (and potentially end-of-life). It is therefore likely to be reached by the low-pressure shaft 11 under flight conditions. This redline speed is part of the data declared in the engine certification (“type certificate data sheet”). In fact, this rotation speed is usually used as a reference speed for dimensioning propulsion systems 1 and in certain certification tests (such as blade loss or rotor integrity tests).

The propulsion system 1 also has an overall compression ratio, which corresponds to the pressure ratio between the outlet pressure of the high-pressure compressor 5 and the inlet pressure of the fan rotor 9 (measured at the root of the fan rotor 9) greater than or equal to 40 and less than or equal to 70, for example greater than or equal to 44 and less than or equal to 55.

In order to optimise the performance of the propulsion system 1 in terms of specific fuel consumption, mass and drag, while maintaining an acceptable mechanical loading and aerodynamic loading for the fan section 2, the propulsion system 1 is configured so that the fan rotor 9 has an aerodynamic loading parameter Kₐₑᵣₒ greater than or equal to 0.07 and less than or equal to 0.12, and a mechanical load parameter K_{meca} greater than or equal to 11.5×10⁶ rev²·m² min⁻² and less than or equal to 20.0×10⁶ rev²·m²·min⁻².

The aerodynamic load parameter Kₐₑᵣₒ represents the aerodynamic torque that is applied to a fan blade 14 of the fan rotor 9, between the hub 13 and the tip 21 of the fan blade 14, and can be expressed by the following formula:

$${k}_{a e r o} = \frac{F * {( F N * \frac{B P {R}^{0.2}}{1000} )}^{1.35}}{n \times \frac{{( ω * \frac{π}{30} )}^{2}}{4} \times ( {R}_{e}^{4} - {R}_{i}^{4} ) * ( {R}_{e} - {R}_{i} )}$$

where: FN is the thrust generated by the propulsion system and is expressed in newtons (N);
BPR is the bypass ratio of the propulsion system 1;
n is the number of blades 14 in the fan rotor 9;
ω is the redline speed of the fan rotor 9, in revolutions per minute (rev/min), which corresponds to the absolute maximum speed likely to be encountered by the fan shaft throughout the flight;
Rₑ is the outer radius of the fan rotor 9 and corresponds to a distance between the axis of rotation X and a point of intersection between a tip 21 and a leading edge 22 of the blades 14 of the fan rotor 9, and is expressed in metres (m);
Rᵢ is the inner radius of the fan rotor and corresponds to a distance between the axis of rotation X and a point of intersection between the leading edge of the blades 14 of the fan rotor 9 and a surface of the fan rotor 9 which radially inwardly delimits a flow stream in the fan rotor 9 and is expressed in metres (m); and

$$F = 39.7 {N}^{- 1.35} . {( rev / min )}^{- 2} . {m}^{- 5} .$$

As mentioned previously, FN is determined when propulsion system 1 is stationary, uninstalled, in take-off speed, in a standard atmosphere (as defined by the International Civil Aviation Organisation (ICAO) manual, Doc 7488/3, 3^{rd} edition) and at sea level. The radii Rₑ and Rᵢ on the other hand, are determined when the propulsion system 1 is cold in order to simplify the measurements.

The leading edge 22 is configured to extend facing the flow of gases entering the fan rotor 9. It corresponds to the front part of an aerodynamic profile which faces the airflow and divides the airflow into an intrados flow and an extrados flow.

The mechanical load parameter K_{meca} reflects the stress applied to a fan blade at the inner radius Rᵢ of the fan rotor 9 (at the bottom of the part of the fan blade 14 that is configured to extend into the

$${k}_{m e c a} = {ω}^{2} \times S$$

where S is the surface area of the flow stream at the inlet of the fan rotor 9, which is equal to π×(Rₑ²−Rᵢ²) and is expressed in square metres.

The centrifugal forces applied to the fan blades 14 of a fan rotor 9, the aerodynamic load parameter Kₐₑᵣₒ of which is greater than or equal to 0.07 and less than or equal to 0.12, and for which the mechanical load parameter K_{meca} is greater than or equal to 11.5×10⁶ rev²·m²·min⁻² and less than or equal to 20.0×10⁶ rev²·m²·min⁻², are moderate. On the other hand, the aerodynamic forces are higher than in engines with conventional reducers, but remain acceptable. In particular, the fan shaft 20 (and indirectly the low-pressure shaft 11) of the propulsion system 1 is capable of transmitting the aerodynamic torque to the fan rotor 9, for example via splines or a bolted connection, without risking accidental breakage or reducing the service life of the fan section 2.

In order to reduce the mechanical load parameter K_{meca} of the fan section 2, it is possible, for example, to modify the hub-tip ratio of the fan rotor 9. The hub-tip ratio corresponds to the ratio between the inner radius Rᵢ and the outer radius Rₑ of the fan rotor 9. The hub-tip ratio can be modified by changing the diameter D of the fan rotor 9 (which is equal to twice the outer radius Rₑ—note that as FIG. 2 is a partial view, the diameter D is only partially visible) and/or by changing the inner radius Rᵢ of the fan rotor 9. However, increasing the diameter of the fan rotor 9 has the effect of increasing the centrifugal forces applied to the fan blades 14. Consequently, the hub-tip ratio is modified, for example, by decreasing the outer radius Re of the fan rotor 9 or by increasing the inner radius Rᵢ of the fan rotor 9. The hub-tip ratio of the fan rotor 9 may be, for example, between 0.22 and 0.32. In the case of a fixed pitch fan rotor, the hub-tip ratio may be between 0.22 and 0.32. In the case of a variable pitch fan rotor, the hub-tip ratio is, for example, between 0.24 and 0.32 in order to allow integration of the pitch change mechanism 15. If applicable, in order to achieve such hub-tip ratios, the configuration of the fan shaft 20 and/or of the bearings which support the fan shaft 20 can be adapted in order to facilitate the integration of the fan rotor 9 and the various components of the propulsion system 1 placed upstream of the reduction mechanism 19.

In order to obtain an aerodynamic load parameter Kₐₑᵣₒ between 0.07 and 0.12, the fan rotor 9 comprises at least twelve fan blades 14 and at most eighteen fan blades 14, for example at least fourteen fan blades 14 and at most sixteen fan blades 14.

The outer radius Re of the fan rotor (9) can then be between 40 inches (101.6 cm) and 92.5 inches (233.7 cm) inclusive, for example between 60 inches (152.4 cm) and 85 inches (215.9 cm) inclusive, for example of the order of 478 inches (198.1 cm), which makes it possible to integrate the propulsion system 1 in a conventional manner, in particular under the wing of an aircraft.

Such an outer radius Re, combined with a hub-tip ratio of between 0.22 and 0.32, therefore makes it possible to minimise drag, without penalising the mechanical loading, the aerodynamic loading of the fan rotor or the pressure ratio of the fan.

A propulsion system 1 having mechanical K_{meca} and aerodynamic aero loading parameters as described above can then have a high bypass ratio, even when the thrust class of the propulsion system is medium. Typically, the propulsion system 1 can be configured to provide a thrust of between 18,000 lbf (80,068 N) and 51,000 lbf (222,411 N), for example between 20,000 lbf (88,964 N) and 35,000 lbf (155,688 N) and have a bypass ratio greater than or equal to 10, in particular greater than or equal to 40, for example between 40 and 80 inclusive. The propulsion system 1 can therefore have a high bypass ratio while still being able to be integrated under the wing of an aircraft 100.

The peripheral speed at the tip 21 of the blades 14 of the fan rotor or rotors 9 may also be between 210 m/s and 260 m/s in the case of one or more unducted fan rotors 9.

The reduction ratio of the reduction mechanism 19 may be between 5.0 and 11.0. Such reduction ratios then enable a fan section 2 to be obtained, in which the fan rotor 9 turns at a rotation speed ω such that the aerodynamic load parameter is greater than or equal to 0.07 and less than or equal to 0.12, and that the mechanical load parameter is greater than or equal to 11.5×10⁶ rev²·m² min⁻² and less than or equal to 20.0×10⁶ rev²·m² min⁻².

A twin-spool propulsion system 1 having an aerodynamic load parameter Kₐₑᵣₒ greater than or equal to 0.07 and less than or equal to 0.12, and a mechanical load parameter K_{meca} greater than or equal to 11.5×10⁶ rev²·m²·min⁻² and less than or equal to 20.0×10⁶ rev²·m²·min⁻², may in particular comprise a two-stage high-pressure turbine 7, a high-pressure compressor 5 comprising at least eight stages and at most eleven stages, a low-pressure turbine 8 comprising at least three stages and at most five stages and a low-pressure compressor 4 comprising at least two stages and at most four stages.

### Comparative Example

Engine 1 is a twin-spool propulsion system comprising an unducted fan section 2 corresponding to the current technical standard (at the date of filing of the present application) which we are seeking to improve.

Engine 2 is a twin-spool propulsion system 1 comprising an unducted fan section 2 in accordance with the teachings of the present application, having an aerodynamic load parameter Kₐₑᵣₒ equal to 0.075 and a mechanical load parameter K_{meca} equal to 14.6×10⁶ rev²·m²·min⁻².

| Dimensioning | | | Engine 2 | |
|---|---|---|---|---|
| parameter (SLS | | | (according to the | |
| unless otherwise | Engine 1 | | disclosure of the | |
| indicated) | (reference engine) | | present application) | |
| Engine thrust (FN) | 125,482N | | 129,558N | |
| Number of fan blades (n) | 12 | | 12 | |
| Outer radius (Re) | 2.3495 | m | 2.032 | m |
| Inner radius (Ri) | 0.5874 | m | 0.508 | m |
| Bypass ratio (BPR) | 50 | | 40 | |
| Redline speed of the | 827 | rev/min | 1096 | rev/min |
| fan rotor 9 (ω) | | | | |
| Aerodynamic load | 0.065 | | 0.075 | |
| parameter (kₐₑᵣₒ) | | | | |
| Mechanical load | 11.1 × 10⁶ | | 14.6 × 10⁶ | |
| parameter (k_{meca}) | rev² · m² · min⁻² | | rev² · m² · min⁻² | |
| Pressure ratio of the fan | 1.06 | | 1.08 | |
| Reduction ratio | 10.59 | | 10.60 | |
| Peripheral speed of the | 180.9 | m/s | 207.3 | m/s |
| fan rotor blades | | | | |
| Hub-tip ratio of the | 0.25 | | 0.25 | |
| fan rotor | | | | |
| High-pressure shaft | 21,400 | rev/min | 23,454 | rev/min |
| redline speed | | | | |
| Low-pressure shaft | 8756 | rev/min | 11,617 | rev/min |
| redline speed (N₁) | | | | |
| Low-pressure compressor | 1.85 | | 1.85 | |
| compression ratio | | | | |
| Overall compression | 42 | | 50 | |
| ratio | | | | |
| Number of stages of | 2 | | 2 | |
| the low-pressure | | | | |
| compressor | | | | |
| Number of stages of | 10 | | 10 | |
| the high-pressure | | | | |
| compressor 5 | | | | |
| Number of stages of | 2 | | 2 | |
| the high-pressure | | | | |
| turbine 7 | | | | |
| Number of stages of | 4 | | 3 | |
| the low-pressure | | | | |
| compressor 8 | | | | |
| Temperature at the inlet | 1800° | C. | 1850° | C. |
| of the high-pressure | | | | |
| turbine 7 | | | | |
| Temperature at the inlet | 1030° | C. | 1028° | C. |
| of the low-pressure | | | | |
| turbine 8 | | | | |

| | | |
|---|---|---|
| N₁²S | 26.75 × 10⁶ | 45.63 × 10⁶ |
| (where S is the outlet | (rev/min)²m² | (rev/min)²m² |
| cross-section of the | | |
| low-pressure turbine 8) | | |

Engine 1 has an aerodynamic load parameter less than 0.07 and a mechanical load parameter less than 11.5×10⁶ rev²·m²·min⁻². Engine 1 has a low aerodynamic load and a low mechanical load for the benefit of fan efficiency at the expense of the size and mass of the fan. The size of the fan has a significant impact on the installation of the engine on aircraft.

The integration of Engine 2 into the aircraft is simplified, compared with Engine 1, without degrading its energy performance. By increasing the aerodynamic load and the fan pressure ratio, it is possible to reduce the fan diameter while maintaining the thrust.

This is facilitated by the increase in mechanical load, which increases the rotation speed of the fan rotor.

Compared with Engine 1, the fan section 2 of Engine 2 is subjected to slightly greater mechanical and aerodynamic stresses, in particular at take-off, while remaining within an acceptable range for the sizing of the engine, so that the fan shaft 10 is able to transmit the aerodynamic torque to the fan rotor 9. On the other hand, Engine 2 is more compact and has a lower mass than Engine 1, due in particular to the reduction in its diameter and bypass ratio, without reducing its efficiency. In the present comparative example, the reduction in mass of the fan section 2 is estimated at around twenty percent. Insofar as the fan section represents a third of the mass of the propulsion system 1, this amounts to reducing the mass of the propulsion system 1 by approximately 7%, with induced effects on the aircraft (cantilever mass, reduction in the diameter of the fan rotor 9, etc.). Engine 2 can therefore be more easily installed on an aircraft 100, with the same inlet temperature to the low-pressure turbine 8 and the same fan thrust.

In order to move from the (reference) Engine 1 to the (disclosure-compliant) Engine 2, the fan diameter D and the bypass ratio BPR have been reduced, thus improving the integration of Engine 2. On the other hand, the pressure ratio of the Engine 2 fan section has been slightly increased (while remaining less than 1.2) to maintain an equivalent thrust. Moreover, the overall compression ratio has been increased without increasing the inlet temperature of the high-pressure turbine 7, which improves the efficiency of the primary spool without increasing the thermal load on the low-pressure turbine 8. Finally, as the temperature of the low-pressure turbine 8 has been kept stable, it has been possible to increase its mechanical load (N₁²S) in order to reduce its number of stages.

It is possible to increase the value of the aerodynamic load parameter with a limited impact on fan efficiency, by reducing the fan blades. Reducing the elongation of the fan blades is generally considered to be unfavourable for the efficiency of the fan and the vibratory situation of the blades with respect to the first torsion mode.

However, improved aerodynamic methods can further minimise the impact on fan efficiency. Reducing the blade height and using a three-dimensionally woven composite with an appropriate weave pattern, or incorporating stiffer fibres, can restore the vibration situation with respect to the first torsion mode.

The use of fan blades comprising a three-dimensionally woven composite material with stiffer fibres also makes it possible to withstand the increase in centrifugal mechanical stresses, in particular in the event of bird ingestion. The use of bearing steels with increased mechanical properties or ceramic rolling elements makes it possible to have the same hub ratio on Engine 2 as on Engine 1, despite the increase in the mechanical load parameter. The use of a titanium alloy with improved mechanical properties for the hub helps to achieve the target hub ratio.

The overall compression ratio and high-pressure turbine inlet temperature of Engine 2 have also been increased to improve the thermal efficiency of the engine.

1-16. (canceled)

17. An propulsion system comprising:
a drive shaft rotatable about an axis of rotation;
a fan shaft;
a fan section comprising a ducted fan rotor configured to be rotated by the fan shaft, the ducted fan rotor comprising a plurality of blades; and
a reduction structure coupling the drive shaft and the fan shaft in order to drive the fan shaft at a rotation speed less than a rotation speed of the drive shaft;
wherein the propulsion system is configured such that the ducted fan rotor has an aerodynamic load parameter greater than or equal to 0.10 and less than or equal to 0.18, and a mechanical load parameter greater than or equal to 20.0×10⁶ rev·m²·min⁻¹ and less than or equal to 32.0×10⁶ rev·m²·min⁻¹,
wherein the aerodynamic load and the mechanical load are defined by the following formulas:
$${k}_{a e r o} = \frac{F * {( F N * \frac{B P {R}^{0.2}}{1000} )}^{1.35}}{n \times \frac{{( ω * \frac{π}{30} )}^{2}}{4} \times ( {R}_{e}^{4} - {R}_{i}^{4} ) * ( {R}_{e} - {R}_{i} )}$$
$${k}_{m e c a} = {ω}^{2} \times S$$
where:
Kₐₑᵣₒ is the aerodynamic load parameter;
K_{meca} is the mechanical load parameter;
FN is a thrust generated by the propulsion system when the propulsion system is stationary, in take-off speed, in a standard atmosphere and at sea level and is expressed in newtons;
BPR is a bypass ratio of the propulsion system and is measured when the propulsion system is stationary, in take-off speed, in a standard atmosphere and at sea level;
n is a number of plurality of blades in the ducted fan rotor;
$$F = 39.7 {N}^{- 1.35} . {( rev / min )}^{- 2} . {m}^{- 5}$$
Rₑ is an outer radius of the ducted fan rotor and corresponds to a distance between the axis of rotation and a point of intersection between a tip and a leading edge of each of the plurality of blades of the ducted fan rotor, and is expressed in meters;
Rᵢ is an inner radius of the ducted fan rotor and corresponds to a distance between the axis of rotation and a point of intersection between the leading edge of each of the plurality of blades of the ducted fan rotor and a surface of the ducted fan rotor which radially inwardly delimits a flow stream in the ducted fan rotor and is expressed in meters;
ω is a redline speed of the ducted fan rotor and is expressed in revolutions per minute; and
S is a surface area of the flow stream at an inlet of the inlet fan rotor, which is equal to π x and is expressed in square meters.

18. The propulsion system according to claim 17, wherein the outer radius of the ducted fan rotor is between 40 inches and 60 inches inclusive.

19. The propulsion system according to claim 17, wherein a hub-tip ratio of the ducted fan rotor is between 0.22 and 0.32.

20. The propulsion system according to claim 17, wherein the plurality of the blades of the ducted fan rotor comprises at least twelve fan blades and at most twenty-four fan blades.

21. The propulsion system according to claim 17, wherein a reduction ratio of the reduction structure is greater than or equal to 2.5 and less than or equal to 6.

22. The propulsion system according to claim 17, wherein the bypass ratio is greater than or equal to 10.

23. The propulsion system according to claim 17, wherein a peripheral speed at a tip of each of the plurality of blades of the ducted fan rotor, when the propulsion system is stationary, in take-off speed, in a standard atmosphere and at sea level, is between 260 m/s and 400 m/s.

24. The propulsion system according to claim 17, wherein the fan section has a fan compression ratio, corresponding to a pressure ratio between an outlet of the ducted fan rotor and an inlet of the ducted fan rotor, that is less than or equal to 1.45.

25. The propulsion system according to claim 17, wherein the propulsion system is dimensioned such that the thrust is between 18,000 lbf and 51,000 lbf.

26. The propulsion system according to claim 17, further comprising a drive turbine and a compressor connected directly via the drive shaft,
wherein the drive turbine comprises at least three stages and at most five stages.

27. The propulsion system according to claim 26, wherein the compressor comprises at least two stages and at most four stages.

28. The propulsion system according to claim 26, further comprising a high-pressure turbine and a high-pressure compressor connected by a high-pressure shaft, the high-pressure shaft being configured to rotate faster than the drive shaft, the high-pressure turbine being two-stage.

29. The propulsion system according to claim 28, wherein the high-pressure compressor comprises at least eight stages and at most eleven stages.

30. An aircraft comprising at least one of the propulsion system according to claim 17, wherein the at least one of the propulsion system is fixed to the aircraft by a mast.

31. A method for dimensioning a propulsion system comprising a reduction structure coupling a drive shaft and a ducted fan rotor in order to drive the fan rotor at a speed less than a speed of the drive shaft, wherein the fan rotor has an aerodynamic load parameter greater than or equal to 0.10 and less than or equal to 0.18 and a mechanical load parameter greater than or equal to 20.0×10⁶ rev·m²·min⁻¹ and less than or equal to 32.0×10⁶ rev·m²·min⁻¹,
wherein the aerodynamic load and the mechanical load are defined by the following formulas:
$${k}_{a e r o} = \frac{F * {( F N * \frac{B P {R}^{0.2}}{1000} )}^{1.35}}{n \times \frac{{( ω * \frac{π}{30} )}^{2}}{4} \times ( {R}_{e}^{4} - {R}_{i}^{4} ) * ( {R}_{e} - {R}_{i} )}$$
$${k}_{m e c a} = {ω}^{2} \times S$$
where:
Kₐₑᵣₒ is the aerodynamic load parameter;
K_{meca} is the mechanical load parameter;
FN is a thrust generated by the propulsion system when the propulsion system is stationary, in take-off speed, in a standard atmosphere and at sea level and is expressed in newtons;
BPR is a bypass ratio of the propulsion system and is measured when the propulsion system is stationary, in take-off speed, in a standard atmosphere and at sea level;
n is a number of blades in the fan rotor;
$$F = 39.7 {N}^{- 1.35} . {( rev / min )}^{- 2} . {m}^{- 5}$$
Rₑ is an outer radius of the ducted fan rotor and corresponds to a distance between an axis of rotation and a point of intersection between a tip and a leading edge of each of the blades of the ducted fan rotor, and is expressed in meters;
Rᵢ is an inner radius of the ducted fan rotor and corresponds to a distance between the axis of rotation and a point of intersection between the leading edge of each of the blades of the ducted fan rotor and a surface of the ducted fan rotor which radially inwardly delimits a flow stream in the ducted fan rotor and is expressed in meters;
ω is a redline speed of the ducted fan rotor and is expressed in revolutions per minute; and
S is a surface area of the flow stream at an inlet of the fan rotor, which is equal to xx and is expressed in square meters.

32. A method for manufacturing an aeronautical propulsion system, the method comprising:
dimensioning the aeronautical propulsion system in accordance with the method according to claim 31; and
manufacturing the aeronautical propulsion system.
